(19) United States
(12) Patent Application Publication
(10) Pub. No.: US 2026/0151922 A1
(43) Pub. Date: Jun. 4, 2026

(54) DRIVING MODULE

(71) Applicants: HYUNDAI MOTOR COMPANY, Seoul (KR); Kia Corporation, Seoul (KR)

(72) Inventors: Min Woong JEUNG, Hwaseong-si (KR); Ju Young YOON, Hwaseong-si (KR); Dong Hyun LEE, Hwaseong-si (KR); Beom Su KIM, Hwaseong-si (KR); Soon Gi PARK, Hwaseong-si (KR); Hyeon Ah BAE, Hwaseong-si (KR); Duk Chan YOON, Hwaseong-si (KR); Hyun Seop LIM, Hwaseong-si (KR); Kuk Hyun AHN, Hwaseong-si (KR)

(21) Appl. No.: 19/187,698

(22) Filed: Apr. 23, 2025

(30) Foreign Application Priority Data
Dec. 3, 2024 (KR) 10-2024-0177780

(51) Int. Cl. B25J 17/02

(52) U.S. Cl. CPC B25J 17/0275

(57) ABSTRACT

A driving module includes a first driving part including a first rotary shaft, a first motor, and a first link. The driving module further includes a second driving part and a third driving part that are provided at one side of the first driving part and configured to rotate together about the first rotary shaft based on rotation of the first rotary shaft, and a platform provided at one side of the first driving part, the second driving part, and the third driving part. The platform is configured to perform a motion based on receiving power from the first link, a second link provided in the second driving part, and a third link provided in the third driving part.

### CROSS-REFERENCE TO RELATED APPLICATION

This application claims priority to and the benefit of Korean Patent Application No. 10-2024-0177780, filed in the Korean Intellectual Property Office on Dec. 3, 2024, the entire contents of which are incorporated herein by reference.

### TECHNICAL FIELD

The present disclosure relates to a driving module, and more particularly, to a driving module capable of being used to implement a rotational motion of a robot joint.

### BACKGROUND

A device can mimic a motion of a joint of a robot and improve performance of the robot. For example, a robot capable of mimicking a motion of a person's arm may include a device capable of mimicking a motion of a wrist of the person's arm.

In some cases, the device of the robot for mimicking the motion of the wrist may have a small rotatable angle (range of motion) or have difficulty in implementing a compact design. For example, there has been an attempt to implement the motion of the wrist by disposing four motors on the same axis by using a spherical parallel mechanism with three degrees of freedom. In some cases, when the motors are disposed coaxially, mechanical performance may deteriorate, and the rotatable angle may be restricted. In some cases, a structure having a relatively large rotatable angle may implement motions with two degrees of freedom. In some cases, an input shaft may be orthogonal to a rotation axis of the wrist of the robot, which may make it difficult to implement a compact design.

### SUMMARY

The present disclosure describes a novel joint structure for a robot, the joint structure having a structure having a large rotatable angle while having a compact structure.

According to one aspect of the subject matter described in this application, a driving module includes a first driving part comprising a first rotary shaft, a first motor configured to rotate the first rotary shaft, and a first link coupled to one side of the first rotary shaft. The driving module further includes a second driving parts and a third driving part that are disposed at one side of the first driving part and configured to rotate together about the first rotary shaft based on rotation of the first rotary shaft, and a platform disposed at one side of the first driving part, the second driving part, and the third driving part. The second driving part includes a second rotary shaft that is coaxial with the first rotary shaft, a second motor configured to operate the second rotary shaft, and a second link coupled to one side of the second rotary shaft. The third driving part includes a third rotary shaft that is coaxial with the first rotary shaft, a third motor configured to operate the third rotary shaft, and a third link coupled to one side of the third rotary shaft, where the platform is configured to perform a motion based on receiving power from the first link, the second link, and the third link.

Implementations according to this aspect can include one or more of the following features. For example, the platform is rotatably coupled to the second link and the third link. In some examples, the second motor and the third motor can be disposed between the first motor and the platform. In some examples, the second motor can be disposed between the first motor and the third motor.

In some implementations, the first link can include a first link plate region and a first link extension region that extends from the first link plate region toward the platform. In some examples, the second link can include a second link plate region, a first-second link extension region that is fixedly coupled to the second link plate region and extends from the second link plate region, and a second-second link extension region that has (i) a first side rotatably coupled to the first-second link extension region and (ii) a second side rotatably coupled to the platform. In some examples, the third link can include a third link plate region, a first-third link extension region that is fixedly coupled to the third link plate region and extends from the third link plate region, and a second-third link extension region having (i) a first side rotatably coupled to the first-third link extension region and (ii) a second side rotatably coupled to the platform.

In some implementations, the first link plate region, the second link plate region, and the third link plate region can be coaxial with one another. In some examples, the first link plate region, the second link plate region, and the third link plate region can be coaxial with the first rotary shaft.

In some examples, the second-second link extension region can be configured to rotate about (i) a first rotation center axis defined at a first side of the second-second link extension region and (ii) a second rotation center axis that is defined at a second side of the second-second link extension region and orthogonal to the first rotation center axis. In some implementations, the second-third link extension region can be configured to rotate about (i) a first rotation center axis defined at a first side of the second-third link extension region and (ii) a second rotation center axis that is defined at a second side of the second-third link extension region and orthogonal to the first rotation center axis.

In some examples, a first rotation center axis extending from a first side of the second-second link extension region can intersect with a second rotation center axis extending from a second side of the second-second link extension region. In some examples, a third rotation center axis extending from a first side of the second-third link extension region can intersect with a fourth rotation center axis extending from a second side of the second-third link extension region.

In some implementations, the driving module can include a universal joint having (i) a first side fixedly coupled to the first link extension region and (ii) a second side fixedly coupled to the platform. In some examples, the universal joint can be disposed at a position that is passed by (i) a first rotation center axis extending from a first side of the second-second link extension region, (ii) a second rotation center axis extending from a second side of the second-second link extension region, (iii) a third rotation center axis extending from a first side of the second-third link extension region, and (iv) a fourth rotation center axis extending from a second side of the second-third link extension region.

In some examples, the platform can include a platform body region, a first platform extension region that protrudes from the platform body region toward the universal joint and is coupled to the universal joint, a second platform extension region that protrudes from the platform body region toward the second-second link extension region and is rotatably coupled to the second-second link extension region, and a third platform extension region that protrudes from the platform body region toward the second-third link extension region and is rotatably coupled to the second-third link extension region.

In some implementations, a distance between the first platform extension region and the second platform extension region in a circumferential direction of the platform body region can correspond to a distance between the first platform extension region and the third platform extension region in the circumferential direction. In some examples, the second-second link extension region and the second-third link extension region can be identical to each other and interchangeable with each other.

In some implementations, the second motor and the third motor can be disposed between the first motor and the universal joint, where the second motor is disposed between the first motor and the third motor.

### BRIEF DESCRIPTION OF THE DRAWINGS

FIG. 1 is a view conceptually illustrating an example of a driving module.

FIG. 2 is a first perspective view showing an example of the driving module.

FIG. 3 is a view illustrating an example of a platform, which is rotated by a predetermined angle about a first rotary shaft by an operation of a first driving part in a state in FIG. 2.

FIG. 4 is a cross-sectional view illustrating the driving module and explaining the first driving part.

FIG. 5 is a cross-sectional view illustrating the driving module and explaining a second driving part.

FIG. 6 is a cross-sectional view illustrating the driving module and explaining a third driving part.

FIGS. 7 and 8 are views for explaining a state in which the platform performs a first rotational motion in a state in which the first driving part is stopped in the driving module.

FIGS. 9 and 10 are views for explaining a state in which the platform performs a second rotational motion in the state in which the first driving part is stopped in the driving module.

### DETAILED DESCRIPTION

Hereinafter, a structure and an operational principle of a driving module will be described with reference to the drawings.

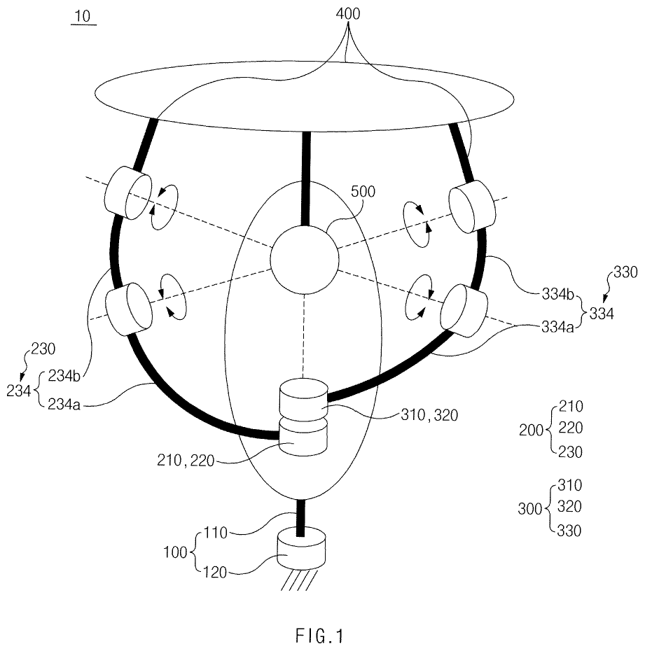

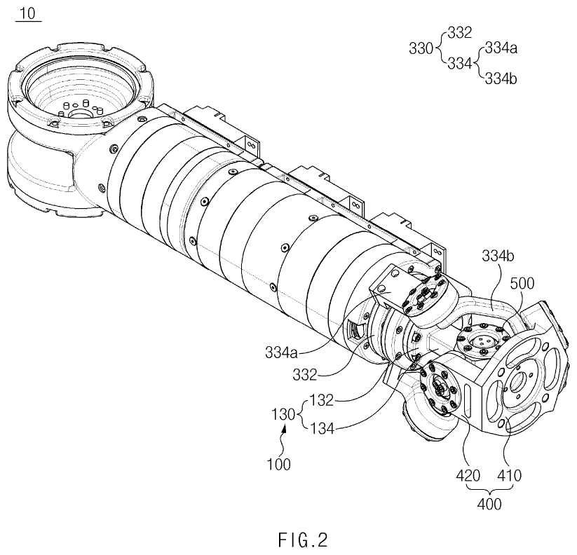

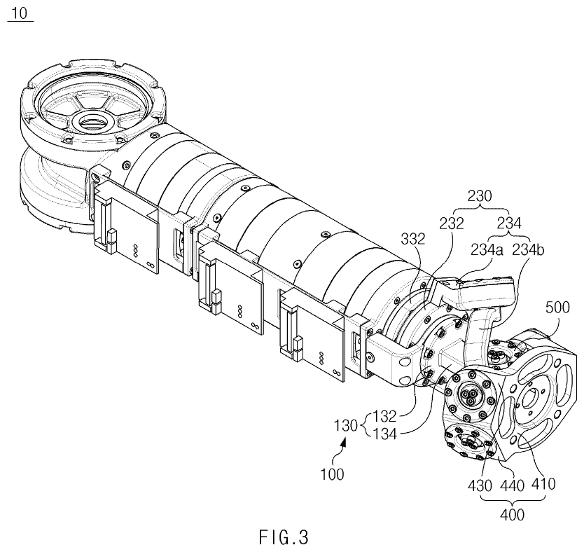

FIG. 1 is a view conceptually illustrating an example of a driving module. FIG. 2 is a first perspective view of the driving module, and FIG. 3 is a view illustrating a state in which a platform is rotated by a predetermined angle about a first rotary shaft by an operation of a first driving part in a state in FIG. 2.

With reference to FIGS. 1 to 3, a driving module 10 can include a first driving part 100 including a first rotary shaft 110, a first motor 120 configured to rotate the first rotary shaft 110, and a first link 130 coupled to one side of the first rotary shaft 110, and second and third driving parts 200 and 300 provided at one side of the first driving part 100 and configured to rotate together about the first rotary shaft 110 in conjunction with the rotation of the first rotary shaft 110. That is, in case that the first rotary shaft 110 is rotated by the first motor 120, the second driving part 200 and the third driving part 300 can also rotate about the first rotary shaft 110.

In addition, the driving module 10 can further include a platform 400 provided at one side of the first driving part 100, the second driving part 200, and the third driving part 300. More specifically, when the first rotary shaft 110 of the first driving part 100 rotates, the platform 400 can also rotate about the first rotary shaft 110.

In some examples, the second driving part 200 can include a second rotary shaft 210 provided coaxially with the first rotary shaft 110, a second motor 220 configured to operate the second rotary shaft 210, and a second link 230 coupled to one side of the second rotary shaft 210. In addition, the third driving part 300 can include a third rotary shaft 310 provided coaxially with the first rotary shaft 110, a third motor 320 configured to operate the third rotary shaft 310, and a third link 330 coupled to one side of the third rotary shaft 310.

In some implementations, the configuration in which the motor operates the rotary shaft can include not only a case in which the motor is connected directly to the rotary shaft but also a case in which a power transmission member (e.g., a speed reducer) is disposed between the motor and the rotary shaft and driving power from the motor is transmitted to the rotary shaft through the power transmission member.

In some implementations, the platform 400 can be configured to perform motions by receiving power from the first link 130, the second link 230, and the third link 330. More specifically, the platform 400 can be rotatably coupled to the second link 230 and the third link 330. In addition, as described below, the platform 400 can be rotatably connected to the first link 130 by another mediation component.

The driving module 10 can be a device for implementing a rotational motion of a robot joint. For example, the driving module 10 can be configured to implement a motion of a wrist provided at an end of an arm of the robot. In this case, as described below, the posture of the platform 400 can be changed by the operations of the first to third driving parts 100, 200, and 300. In particular, the platform 400 can implement rotational motions with three degrees of freedom by the first to third driving parts.

More specifically, the first link 130 can be configured to allow the platform 400 to perform a rotational motion (e.g., roll motion) about the first rotary shaft 110, the second link 230 can be configured to allow the platform 400 to perform a rotational motion (e.g., pitch motion) about another rotary shaft intersecting the first rotary shaft 110, and the third link 330 can be configured to allow the platform 400 to perform a rotational motion (e.g., yaw motion) about still another rotary shaft intersecting the first rotary shaft 110. In particular, the angle in the rotatable range of the rotational motion with three degrees of freedom can be increased or maximized. For example, a range of the roll motion can be −180 to 180 degrees about a first axis, a range of the pitch motion can be −20 to 60 degrees about a second axis orthogonal to the first axis, and a range of the yaw motion can be −60 to 60 degrees about a third axis orthogonal to the first and second axes.

Hereinafter, a structure of the driving module 10 will be described in detail.

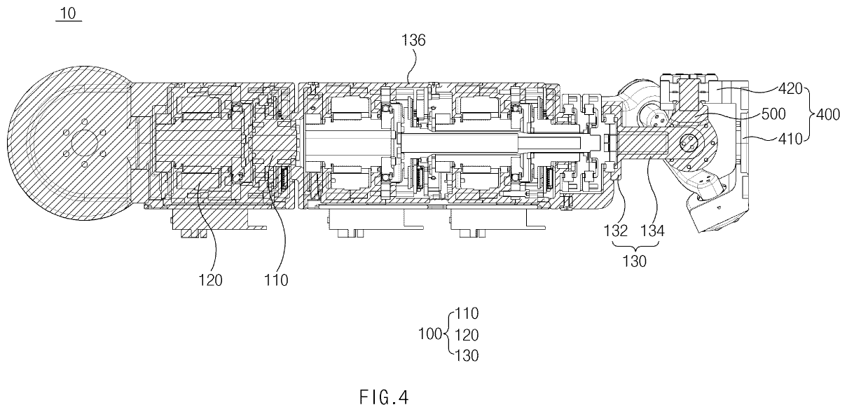

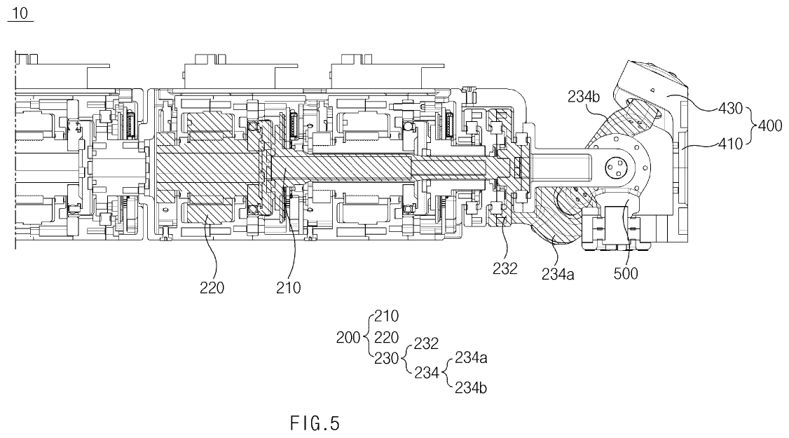

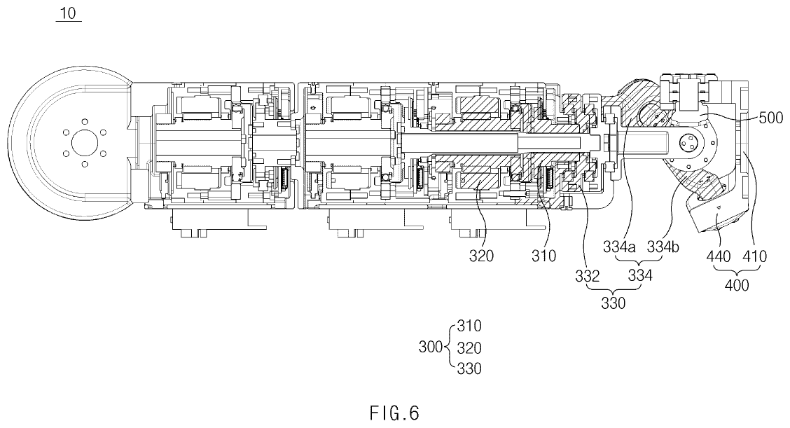

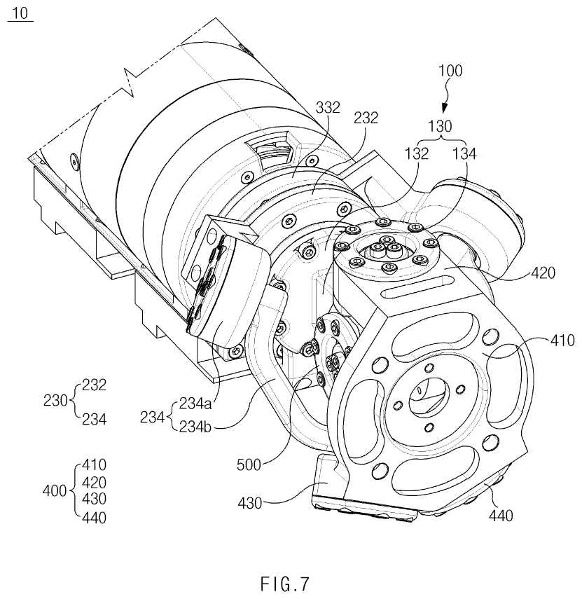

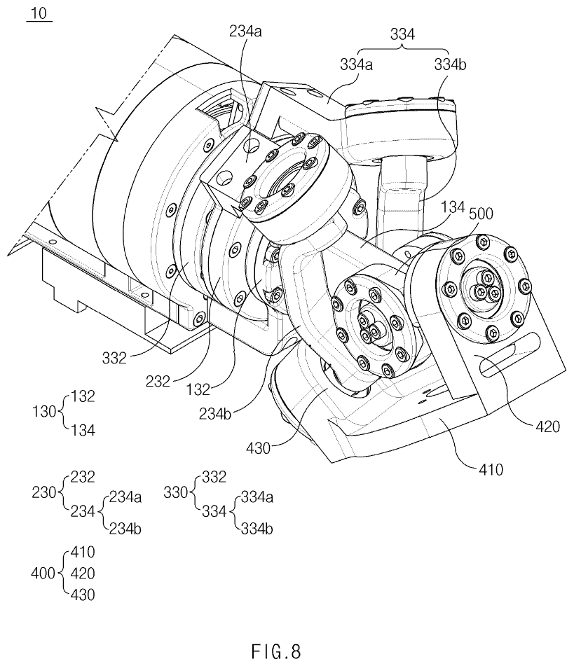

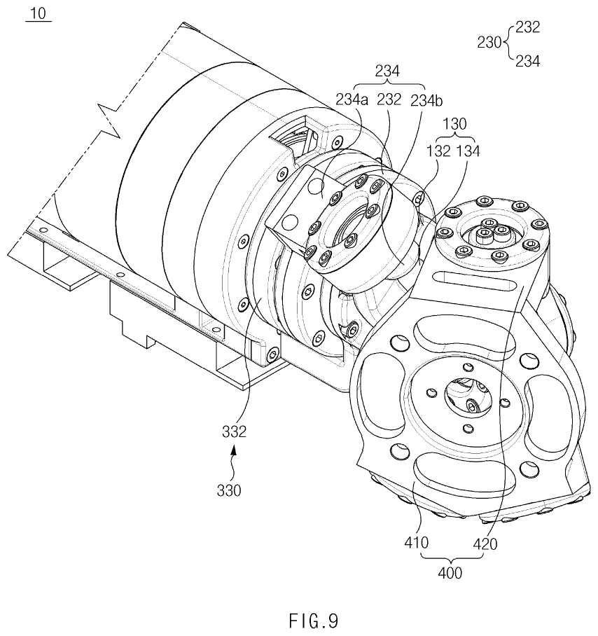

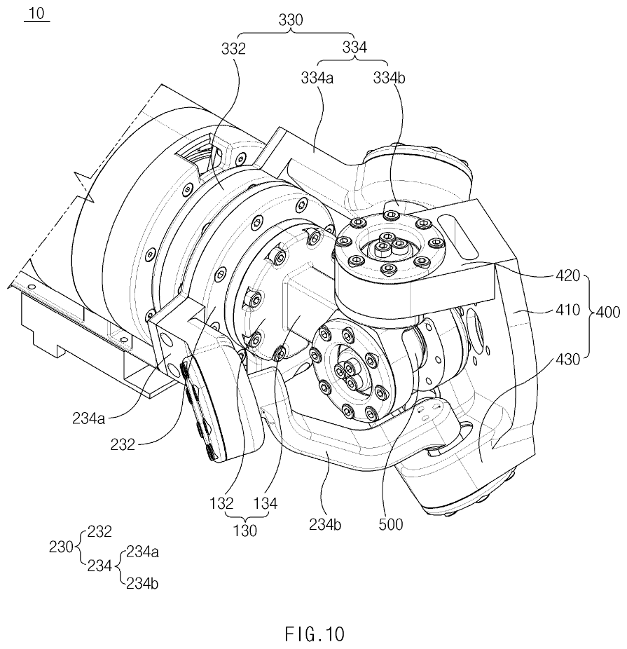

FIG. 4 is a cross-sectional view illustrating the driving module and explaining the first driving part, and FIG. 5 is a cross-sectional view illustrating the driving module and explaining the second driving part. FIG. 6 is a cross-sectional view illustrating the driving module and explaining the third driving part. Further, FIGS. 7 and 8 are views for explaining a state in which the platform performs a first rotational motion in a state in which the first driving part is stopped in the driving module, and FIGS. 9 and 10 are views for explaining a state in which the platform performs a second rotational motion in the state in which the first driving part is stopped in the driving module. More specifically, FIGS. 7 and 8 are views for explaining the pitch motion of the platform, and FIGS. 9 and 10 are views for explaining the yaw motion of the platform.

With reference to FIGS. 4 to 6, the second motor 220 and the third motor 320 can be provided between the first motor 120 and the platform 400. In addition, the second motor 220 can be provided between the first motor 120 and the third motor 320.

In some implementations, the first to third links 130, 230, and 330 can each be divided into a plurality of regions.

For example, as illustrated in FIGS. 7 to 10, the first link 130 can include a first link plate region 132 having an approximate plate shape, and a first link extension region 134 extending from the first link plate region 132 toward the platform 400. The first link plate region 132 and the first link extension region 134 can be fixedly coupled to each other.

In addition, the second link 230 can include a second link plate region 232 having an approximate plate shape, and a second link extension region 234 extending from the second link plate region 232. More specifically, the second link extension region 234 can include a first-second link extension region 234a fixedly coupled to the second link plate region 232, and a second-second link extension region 234b having one side rotatably coupled to the first-second link extension region 234a, and the other side rotatably coupled to the platform 400.

Further, the third link 330 can include a third link plate region 332 having an approximate plate shape, and a third link extension region 334 extending from the third link plate region 332. More specifically, the third link extension region 334 can include a first-third link extension region 334a fixedly coupled to the third link plate region 332, and a second-third link extension region 334b having one side rotatably coupled to the first-third link extension region 334a, and the other side rotatably coupled to the platform 400.

More specifically, as illustrated in FIGS. 7 to 10, the first link plate region 132, the second link plate region 232, and the third link plate region 332 can each be provided coaxially with the first rotary shaft 110 and configured to rotate about the first rotary shaft 110 independently of one another. For example, as illustrated in FIGS. 7 to 10, the first to third link plate regions 132, 232, and 332 can each have an approximately circular plate shape.

In some implementations, the first driving part 100 can further include a body region 136 configured to rotate in conjunction with the rotation of the first rotary shaft 110. The second driving part 200 and the third driving part 300 can be fixed relative to the body region 136. Therefore, in case that the first rotary shaft 110 is rotated by the first motor 120, the second driving part 200 and the third driving part 300 can rotate about the first rotary shaft 110 together with the body region 136. Therefore, the first to third link plate regions 132, 232, and 332 can rotate together when the rotation of the first rotary shaft 110 is viewed from the outside.

In some examples, the motion of the second driving part 200 and the motion of the third driving part 300 may not affect the motion of the first driving part 100. That is, because the first to third link plate regions 132, 232, and 332 are provided coaxially with one another without being physically coupled to one another, the first link plate region 132 may not rotate in case that the second link plate region 232 or the third link plate region 332 is rotated by the second rotary shaft 210 or the third rotary shaft 310.

In some implementations, (i) a rotation center axis of the second-second link extension region 234b at one side of the second-second link extension region 234b and (ii) a rotation center axis of the second-second link extension region 234b at the other side of the second-second link extension region 234b can be perpendicular to each other. That is, a rotation center axis of the second-second link extension region 234b in a region in which the second-second link extension region 234b and the first-second link extension region 234a are coupled can be perpendicular to a rotation center axis of the second-second link extension region 234b in a region in which the second-second link extension region 234b and the platform 400 are coupled.

In some examples, (i) a rotation center axis of the second-third link extension region 334b at one side of the second-third link extension region 334b and (ii) a rotation center axis of the second-third link extension region 334b at the other side of the second-third link extension region 334b can be perpendicular to each other. That is, a rotation center axis of the second-third link extension region 334b in a region in which the second-third link extension region 334b and the first-third link extension region 334a are coupled can be perpendicular to a rotation center axis of the second-third link extension region 334b in a region in which the second-third link extension region 334b and the platform 400 are coupled.

In some examples, (i) an imaginary line made by extending the rotation center axis of the second-second link extension region 234b at one side of the second-second link extension region 234b and (ii) an imaginary line made by extending the rotation center axis of the second-second link extension region 234b at the other side of the second-second link extension region 234b can meet together.

In some examples, (i) an imaginary line made by extending the rotation center axis of the second-third link extension region 334b at one side of the second-third link extension region 334b and (ii) an imaginary line made by extending the rotation center axis of the second-third link extension region 334b at the other side of the second-third link extension region 334b can meet together.

In some examples, as illustrated in FIGS. 4 to 10, the driving module 10 can further include a universal joint 500 having one side fixedly coupled to the first link extension region 134, and the other side fixedly coupled to the platform 400. In some examples, the universal joint can be configured to transmit a rotational motion between two shafts when the two shafts are bent at a predetermined angle. In some examples, the universal joint can be designed to transmit a rotational force in a case in which the two shafts are connected to each other at a predetermined angle without being connected to each other straight.

For example, the universal joint 500 can broadly include a first joint component fixedly coupled to the first link extension region 134, a second joint component rotatably coupled to the platform 400, and a mediation component configured to mediate the connection between the first joint component and the second joint component. In this case, with the mediation component, the second joint component can rotate about two rotation axes relative to the first joint component. That is, the universal joint can be a configuration in which there are two rotation center axes between a component fixedly coupled to the first link extension region 134 and a component fixedly coupled to the platform 400. Therefore, because the universal joint 500 is provided, the platform 400 can perform the rotational motions (i.e., the pitch motion and the yaw motion) about the two different rotation axes by the operation of the second driving part 200 and the operation of the third driving part 300.

With continued reference to the drawings, (i) the imaginary line made by extending the rotation center axis of the second-second link extension region 234b at one side of the second-second link extension region 234b, (ii) the imaginary line made by extending the rotation center axis of the second-second link extension region 234b at the other side of the second-second link extension region 234b, iii) the imaginary line made by extending the rotation center axis of the second-third link extension region 334b at one side of the second-third link extension region 334b, and iv) the imaginary line made by extending the rotation center axis of the second-third link extension region 334b at the other side of the second-third link extension region 334b can pass through a center of the universal joint 500.

In some implementations, the platform 400 can be divided into a plurality of regions. More specifically, as illustrated in FIGS. 7 to 10, the platform 400 can include a platform body region 410, a first platform extension region 420 protruding in a direction from the platform body region 410 toward the universal joint 500 and fixedly coupled to the universal joint 500, a second platform extension region 430 protruding in a direction from the platform body region 410 toward the second-second link extension region 234b and rotatably coupled to the second-second link extension region 234b, and a third platform extension region 440 protruding in a direction from the platform body region 410 toward the second-third link extension region 334b and rotatably coupled to the second-third link extension region 334b. In case that the driving module 10 is applied to a robot, the platform body region 410 can be configured to be coupled directly to an end effector such as a gripper.

In some examples, the platform 400 can have an approximately symmetric shape. More specifically, a distance between the first platform extension region 420 and the second platform extension region 430 measured in a circumferential direction of the platform body region 410 can correspond to a distance between the first platform extension region 420 and the third platform extension region 440. More particularly, the above-mentioned two distances can be equal to each other.

In addition, the second-second link extension region 234b and the second-third link extension region 334b can be identical to each other to the extent that the second-second link extension region 234b and the second-third link extension region 334b are interchangeable with each other. In this case, it can be possible to reduce the number of types of components for manufacturing the driving module 10.

The present disclosure has been described with reference to the limited implementations and the drawings, but the present disclosure is not limited thereby. The present disclosure can be carried out in various forms by those skilled in the art, to which the present disclosure pertains, within the technical spirit of the present disclosure and the scope equivalent to the appended claims.

What is claimed is:

1. A driving module comprising:
a first driving part comprising a first rotary shaft, a first motor configured to rotate the first rotary shaft, and a first link coupled to one side of the first rotary shaft;
a second driving parts and a third driving part that are disposed at one side of the first driving part and configured to rotate together about the first rotary shaft based on rotation of the first rotary shaft; and
a platform disposed at one side of the first driving part, the second driving part, and the third driving part,
wherein the second driving part comprises:
a second rotary shaft that is coaxial with the first rotary shaft,
a second motor configured to operate the second rotary shaft, and
a second link coupled to one side of the second rotary shaft,
wherein the third driving part comprises:
a third rotary shaft that is coaxial with the first rotary shaft,
a third motor configured to operate the third rotary shaft, and
a third link coupled to one side of the third rotary shaft, and
wherein the platform is configured to perform a motion based on movement of the first link, the second link, and the third link.

2. The driving module of claim 1, wherein the platform is rotatably coupled to the second link and the third link.

3. The driving module of claim 2, wherein the second motor and the third motor are disposed between the first motor and the platform.

4. The driving module of claim 3, wherein the second motor is disposed between the first motor and the third motor.

5. The driving module of claim 2, wherein the first link comprises:
a first link plate region; and
a first link extension region that extends from the first link plate region toward the platform.

6. The driving module of claim 5, wherein the second link comprises:
a second link plate region;
a first-second link extension region that is fixedly coupled to the second link plate region and extends from the second link plate region; and
a second-second link extension region that has (i) a first side rotatably coupled to the first-second link extension region and (ii) a second side rotatably coupled to the platform.

7. The driving module of claim 6, wherein the third link comprises:
a third link plate region;
a first-third link extension region that is fixedly coupled to the third link plate region and extends from the third link plate region; and
a second-third link extension region having (i) a first side rotatably coupled to the first-third link extension region and (ii) a second side rotatably coupled to the platform.

8. The driving module of claim 7, wherein the first link plate region, the second link plate region, and the third link plate region are coaxial with one another.

9. The driving module of claim 7, wherein the first link plate region, the second link plate region, and the third link plate region are coaxial with the first rotary shaft.

10. The driving module of claim 6, wherein the second-second link extension region is configured to rotate about (i) a first rotation center axis defined at a first side of the second-second link extension region and (ii) a second rotation center axis that is defined at a second side of the second-second link extension region and orthogonal to the first rotation center axis.

11. The driving module of claim 7, wherein the second-third link extension region is configured to rotate about (i) a first rotation center axis defined at a first side of the second-third link extension region and (ii) a second rotation center axis that is defined at a second side of the second-third link extension region and orthogonal to the first rotation center axis.

12. The driving module of claim 7, wherein a first rotation center axis extending from a first side of the second-second link extension region intersects with a second rotation center axis extending from a second side of the second-second link extension region.

13. The driving module of claim 12, wherein a third rotation center axis extending from a first side of the second-third link extension region intersects with a fourth rotation center axis extending from a second side of the second-third link extension region.

14. The driving module of claim 7, further comprising:
a universal joint having (i) a first side fixedly coupled to the first link extension region and (ii) a second side fixedly coupled to the platform.

15. The driving module of claim 14, wherein the universal joint is disposed at a position that is passed by (i) a first rotation center axis extending from a first side of the second-second link extension region, (ii) a second rotation center axis extending from a second side of the second-second link extension region, (iii) a third rotation center axis extending from a first side of the second-third link extension region, and (iv) a fourth rotation center axis extending from a second side of the second-third link extension region.

16. The driving module of claim 14, wherein the platform comprises:
a platform body region;
a first platform extension region that protrudes from the platform body region toward the universal joint and is coupled to the universal joint;
a second platform extension region that protrudes from the platform body region toward the second-second link extension region and is rotatably coupled to the second-second link extension region; and
a third platform extension region that protrudes from the platform body region toward the second-third link extension region and is rotatably coupled to the second-third link extension region.

17. The driving module of claim 16, wherein a distance between the first platform extension region and the second platform extension region in a circumferential direction of the platform body region corresponds to a distance between the first platform extension region and the third platform extension region in the circumferential direction.

18. The driving module of claim 7, wherein the second-second link extension region and the second-third link extension region are identical to each other and are interchangeable with each other.

19. The driving module of claim 14, wherein the second motor and the third motor are disposed between the first motor and the universal joint.

20. The driving module of claim 19, wherein the second motor is disposed between the first motor and the third motor.
